(19) United States
(12) Patent Application Publication
(10) Pub. No.: US 2004/0194881 A1
(43) Pub. Date: Oct. 7, 2004

(54) Easy de-glazing reactive hot melt adhesive

(76) Inventors: Ju-Ming Hung, Yardley, PA (US); Yue S. Zhang, Somerset, NJ (US); Michael T. Gefri, Blairstown, NJ (US)

Correspondence Address: Charles W. Almer, Counsel, I.P., NATIONAL STARCH AND CHEMICAL COMPANY, 10 Finderne Avenue, Bridgewater, NJ, 08807-0500, US

(21) Appl. No.: 10/408,139

(22) Filed: Apr. 4, 2003

(51) Int. Cl. E06B 3/56; C09J 1/00; C09J 4/00; C09J 5/08

(52) U.S. Cl. 156/329; 156/331.7; 156/344; 52/204.5

(57) ABSTRACT

High green strength reactive hot melt adhesives that allow for easy deglazing of windows are provided.

### FIELD OF THE INVENTION

The invention relates to hot melt adhesives, in particular reactive hot melt adhesives having an improved ability to deglaze windows. This invention also relates to articles, in particular residential and commercial windows, comprising such reactive hot melt adhesives.

### BACKGROUND OF THE INVENTION

Reactive hot melt adhesives have excellent adhesion to glass, wood and vinyl and for this reason are capable of being utilized in window glazing applications. The reactive hot melt adhesives are useful for window glazing because they provide a combination of advantageous properties, including good green strength and processability, over previously utilized adhesives, such as silicone sealant and double sided tape. Reactive hot melt glazing compositions that are utilized in window glazing provide strong, permanent bonding between the glass pane and the window's peripheral glass frame. While the use of reactive hot melt adhesives for glazing applications produces windows having improved cohesive strength and rigidity, deglazing has become more difficult and expensive. Current methods for deglazing structural windows glazed with reactive hot melt adhesives are extremely labor intensive and expensive. It would be advantageous to provide a reactive hot melt adhesive that combines good initial strength and excellent adhesion with adjustable mechanical strength to facilitate deglazing.

### SUMMARY OF THE INVENTION

The invention provides a method of deglazing a finished window. The method of the invention lowers costs by providing a window that may be easily deglazed, thus eliminating the difficulties inherent in deglazing windows containing standard moisture curable reactive hot melt adhesive compositions.

One aspect of the invention is directed to a moisture curable hot melt adhesive composition comprising a multifunctional isocyanate, at least one or more polymeric diols or triols, a polymeric or non-polymeric monofunctional reactant, and at least one functional or non-functional thermoplastic.

Another embodiment of the invention is directed to a method of improving the deglazing properties of a hot melt adhesive comprising adding an effective amount of a monofunctional reactant to a reactive hot melt adhesive formulation.

Yet another embodiment of the invention is directed to a method for separating materials which comprises providing a unit comprising first and second substrates joined together with the reactive hot melt composition of the present invention. The mechanical strength of the reactive hot melt composition is such that the first and second substrates may be easily separated from each other. In an alternative embodiment, the unit may be exposed to certain conditions, such as increased heat, that facilitate the separation of the materials.

Still another aspect of the invention is directed to an article of manufacture comprising the adhesive of the invention.

### DETAILED DESCRIPTION OF THE INVENTION

All percents are percent by weight of the adhesive composition, unless otherwise stated.

A fenestration is an opening in a building, i.e., in a wall or roof. A fenestration product is a door, window or skylight assembly that fits in a building opening and is used to close the opening. In such products it is common to provide a sash which frames or retains a transparent pane, usually glass. The sash can be thought of as a peripheral frame and can be movable or stationary relative to a building frame mounted to a building and within which the sash is carried. In some situations there is no sash and the pane is set directly in the frame for the product. This is sometimes referred to as a direct set.

The pane is usually transparent and may be a single pane. However, due to temperature differentials between the external environment and the internal environment heat losses often occur. For example, in the winter the outside is cold relative to the inside, which is usually heated, and in the summer the inside is air-conditioned and is cooler than the outside. In order to minimize the heat loss and/or condensation problems, an insulating glass unit is often used, wherein multiple spaced but parallel panes are sealed together to form a subassembly which is installed in the sash or frame. The space between the glass panes is insulated, sometimes filled with a gas, and separates the inside and outside panes. This spacing or insulation minimizes condensation and heat loss.

Window as used herein refers to windows intended for installation into new construction, as well as replacement windows and includes, without limitation, single hung windows, double hung windows, sliding windows, pivoting windows, casement windows, patio doors, picture windows, bay windows and storm windows. Included are windows designed for use in residential dwellings, i.e., single and multiply family homes, light commercial (e.g., apartment) buildings, and commercial buildings. Single pane as well as insulating glass units are contemplated for use in the practice of the invention. The windows made in accordance with the invention may be of any desired shape such as square, rectangular, circular, semicircular or the like, and may be of any desired size.

The invention provides an improved fenestration construction which comprises a peripheral frame-like member which defines a central opening and a step-like ledge surface or “glazing leg” adjacent to said central opening for receiving and retaining a glass pane positioned for retention within said central opening and a glazing compound which secures the pane within said frame-like member and which provides for easy deglazing of the window.

The term glazing compound is used herein to refer to what is conventionally referred to in the art as a backbedding compound or glazing sealant, and functions to hold a glass window pane securely in the window frame or sash. The term deglazing is used herein to refer to the process by which the glazing compound is cut from the intersection of the window pane and window frame and the glass window pane is removed from the window frame or sash.

Compositions contemplated for use as glazing compounds in the practice of the invention include liquid polyurethanes, thermoplastic adhesives, polyurethane rubbers, silicone rubbers, reactive silicone hot melts and reactive polyurethane hot melts, and, in particular, foamed formulations thereof. In preferred embodiments of the invention, the glazing compound is a moisture curable reactive hot melt adhesive. Silicone and polyurethane hot melt adhesives, foamed moisture curable silicone and polyurethane hot melt adhesives are preferred in terms of strength, cost and processing time.

It has now been discovered that high green strength reactive hot melt adhesives that are soft and allow for easy deglazing may be prepared using a monofunctional group that is isocyanate, capable of reacting with isocyanate, or capable of forming a urethane linkage. The adhesives of the invention have good green strength and maintain fast setting and crosslinkability.

While a preferred embodiment comprises the deglazing of window glass frames or sashes made of vinyl, aluminum, wood and fiberglass composite sashes and the like are also encompassed by the invention. In the practice of the invention, the glass pane may be deglazed from the exterior of the building (“exterior deglazing”) or from the interior of the building (“interior deglazing”).

While the invention will hereinafter be described in terms of reactive hot melt polyurethane adhesives, it will be understood that the invention is not to be so limited.

The moisture curable, hot melt polyurethane adhesives of the invention may be prepared through the reaction of a mixture of non-polymeric or polymeric monofunctional reactants, with a multifunctional isocyanate-containing compound, one or more polymeric diols or triols, and preferably, a thermoplastic polymer, at a temperature of from about 90° F. to about 350° F. In alternative embodiments, monofunctional isocyanate or monofunctional silane may be utilized to form a more secure compound. The adhesives of the invention most preferably comprise a) a multifunctional isocyanate, MDI being preferred, b) a monofunctional reactant in the range of from about 0.1 to about 80 wt % and preferably from about 1 to about 50 wt % and most preferably from about 3 to about 20 wt %, c) polyester polyol in the range of from about 0 wt % to about 90 wt % and preferably from about 10 to about 70 wt %, and d) polyether polyol in the range of and from about 0 to about 95 wt % and preferably from about 5 to about 80 wt % and most preferably from about 10 to about 70 wt %. The adhesive preferably has a hardness of less than about 70 Shore A and most preferably less than about 50 Shore A.

To obtain the adhesive of the invention, various monofunctional reactants that are capable of reacting with isocyanate, such as hydroxyl, carboxyl, thiol, amine, mercapto and amides may be utilized, whether polymeric or non-polymeric. Any monofunctional grafting agent that is capable of stopping the chain extension of polyurethane may be used for this purpose. The molecular weight range of the chain stopper may extend from a very small molecule such as a two or four carbon content to an oligomer or even a polymer. One preferred reactant is low molecular weight linear polyethylene monoalcohols, commercially available as UNILIN from Baker Petrolites. These materials have melting points ranging from about 60° C. to about 110° C. By partially capping the isocyanate end group of the polyurethane prepolymers with monoalcohols, a hot melt that is able to crosslink under moisture is obtained. Upon cooling from the melt, the setting of the short polyethylene segments at the end of the prepolymer freezes the movement of the entire chain, resulting in the setting of the hot melt adhesive. Another preferred reactant is polyethylene-block-polyethylene glycol, commercially available as UNITHOX (Baker Petrolites). As with the monoalcohol reactant, the polymer based tail would generate green strength, but the uncapped-NCO end would still be available for curing and forming a crosslinked polyurethane network. A still further preferred embodiment are ring-opened polyesters, such as polycaprolactone from Solvay, and polyamides that are monofunctional.

The reactive hot melt compositions of the invention are useful for bonding articles composed of a wide variety of substrates (materials), including but not limited to wood, metal, polymeric plastics, glass and textiles. As such, these adhesives find particular use in applications such as use in water towers, for bonding to exterior surfaces, and e.g., in marine and automotive applications. Other non-limiting uses include textile bonding applications (carpet and clothing), use in the manufacture of footwear (shoes), use as a glazing/backbedding compound in the manufacture of windows, use in the manufacture of doors including entry doors, garage doors and the like, use in the manufacture of architectural panels, use in bonding components on the exterior of vehicles, and the like.

The urethane prepolymers that can be used to prepare the adhesives of the invention are those conventionally used in the production of polyurethane hot melt adhesive compositions. Any suitable compound, which contains one or more isocyanate groups, may be used for preparing the urethane prepolymers.

Organic polyisocyanates, which may be used to practice the invention, include alkylene diisocyanates, cycloalkylene diisocyanates, aromatic diisocyanates and aliphatic-aromatic diisocyanates. Specific examples of suitable isocyanate-containing compounds include, but are not limited to, ethylene diisocyanate, ethylidene diisocyanate, propylene diisocyanate, butylene diisocyanate, trimethylene diisocyanate, hexamethylene diisocyanate, toluene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well known in the art. Preferred isocyanate-containing compounds are methylenebisphenyidiisocyanate (MDI), isophoronediisocyanate (IPDI), hydrogenated methylenebisphenyldiisocyanate (HMDI) and toluene diisocyanate (TDI). In addition to the above compounds, it is also desirable to utilize monofunctional isocyanates in the composition.

Most commonly, the prepolymer is prepared by the polymerization of a polyisocyanate with a polyol, most preferably the polymerization of a diisocyanate with a diol. The polyols used include polyhydroxy ethers (substituted or unsubstituted polyalkylene ether glycols or polyhydroxy polyalkylene ethers), polyhydroxy polyesters, the ethylene or propylene oxide adducts of polyols and the monosubstituted esters of glycerol, as well as mixtures thereof. The polyol is typically used in an amount of between about 10 to about 70 parts by weight.

Preferably the adhesive is prepared by including a thermoplastic polymer. The thermoplastic polymer may be either a functional or a non-functional thermoplastic. Suitable thermoplastic polymers include acrylic polymers, functional acrylic polymers, non-functional acyrlic polymers, hydroxy functional acrylic polymers, polyvinyl acetate, polyvinyl chloride, methylene polyvinyl ether, cellulose acetate, styrene acrylonitrile, amorphous polyolefin, thermoplastic urethane, polyacrylonitrile, polybutadiene diol, isobutylene diol and mixtures thereof.

Examples of polyether polyols include a linear and/or branched polyether having plural numbers of ether bondings and one or more hydroxyl groups, and contain substantially no functional group other than the hydroxyl groups. Examples of the polyether polyol may include polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct at least one compound selected from the group consisting of ethylene glycol, propylene glycol, diethylene glycol, dipropylene glycol, triethylene glycol, 2-ethylhexanediol-1,3,glycerin, 1,2,6-hexane triol, trimethylol propane, trimethylol ethane, tris(hydroxyphenyl)propane, triethanolamine, triisopropanolamine, ethylenediamine and ethanolamine; with at least one compound selected from the group consisting of ethylene oxide, propylene oxide and butylene oxide.

A number of suitable polyols are commercially available. Non-limiting examples include CP4701 (Dow Chemicals), Niax 11-34 (Union Carbide Corp), Desmorphen 3900 (Bayer), Propylan M12 (Lankro Chemicals), Highflex 303 (Daiichi Kogyo Seiyaku K. K.) and Daltocel T 32-75 (ICI). Polymer polyols are also suitable, i.e., graft polyols containing a proportion of a vinyl monomer, polymerized in situ, e.g., Niax 34-28.

Polyester polyols are formed from the condensation of one or more polyhydric alcohols having from 2 to 15 carbon atoms with one or more polycarboxylic acids having from 2 to 14 carbon atoms. Examples of suitable polyhydric alcohols include ethylene glycol, propylene glycol such as 1,2-propylene glycol and 1,3-propylene glycol, glycerol, pentaerythritol, trimethylolpropane, 1,4,6-octanetriol, butanediol, pentanediol, hexanediol, dodecanediol, octanediol, chloropentanediol, glycerol monallyl ether, glycerol monoethyl ether, diethylene glycol, 2-ethylhexanediol-1,4, cyclohexanediol-1,4, 1,2,6-hexanetriol, 1,3,5-hexanetriol, 1,3-bis-(2-hydroxyethoxy)propane and the like. Examples of polycarboxylic acids include phthalic acid, isophthalic acid, terephthalic acid, tetrachlorophthalic acid, maleic acid, dodecylmaleic acid, octadecenylmaleic acid, fumaric acid, aconitic acid, trimellitic acid, tricarballylic acid, 3,3′-thiodipropionic acid, succinic acid, adipic acid, malonic acid, glutaric acid, pimelic acid, sebacic acid, cyclohexane-1,2-dicarboxylic acid, 1,4-cyclohexadiene-1,2-dicarboxylic acid, 3-methyl-3,5-cyclohexadiene-1,2-dicarboxylic acid and the corresponding acid anhydrides, acid chlorides and acid esters such as phthalic anhydride, phthaloyl chloride and the dimethyl ester of phthalic acid. Preferred polycarboxylic acids are the aliphatic and cycloaliphatic dicarboxylic acids containing no more than 14 carbon atoms and the aromatic dicarboxylic acids containing no more than 14 atoms.

Commercially available polyols which may be used in the practice of the invention include polyethers such as ARCOL PPG 2025 (Bayer), PolyG 20-56 (Arch) and Pluracol P-2010 (BASF), polyesters such as Dynacoll 7360 (Creanova), Fomrez 66-32 (Crompton) and Rucoflex S-105-30 (Bayer) and polybutadiene such as PolyBD R-45HTLO (Elf Atochem).

In addition, the urethane prepolymers may be prepared by the reaction of a polyisocyanate with a polyamino or a polymercapto-containing compound such as diamino polypropylene glycol or diamino polyethylene glycol or polythioethers such as the condensation products of thiodiglycol either alone or in combination with other glycols such as ethylene glycol, 1,2-propylene glycol or with other polyhydroxy compounds disclosed above. In accordance with one embodiment of the invention, the hydroxyl containing acrylic polymer may function as the polyol component, in which case, no additional polyol need be added to the reaction.

Further, small amounts of low molecular weight dihydroxy, diamino, or amino hydroxy compounds may be used such as saturated and unsaturated glycols, e.g., ethylene glycol or condensates thereof such as diethylene glycol, triethylene glycol, and the like; ethylene diamine, hexamethylene diamine and the like; ethanolamine, propanolamine, N-methyldiethanolamine and the like.

Virtually any ethylenically unsaturated monomer containing a functionality averaging one may be utilized in the compositions of the present invention. Functional monomers include, without limitation acid, hydroxy, amine, isocyanate, and thio functional monomers. Hydroxyl functionality is preferred and is described in detail herein.

Most commonly employed are hydroxyl substituted C₁ to C₁₂ esters of acrylic and methacrylic acids including, but not limited to hydroxyl substituted methyl acrylate, ethyl acrylate, n-butyl acrylate, 2-ethylhexyl acrylate, isobutyl acrylate, n-propyl or iso-propyl acrylate or the corresponding methacrylates. Mixtures of compatible (meth)acrylate monomers may also be used. Additional monomers that may be used include the hydroxyl substituted vinyl esters (vinyl acetate and vinyl propionate), vinyl ethers, fumarates, maleates, styrene, acrylonitrile, as well as comonomers thereof.

These monomers may be blended with other copolymerizable comonomers as formulated so as to have a wide range of Tg values, as between about −60° C. and 105° C., preferably 15° C. to 85° C. Suitable comonomers include the C₁ to C₁₂ esters of acrylic and methacrylic acids including, but not limited to methyl acrylate, ethyl acrylate, n-butyl acrylate, isobutyl acrylate, 2-ethylhexyl acrylate, n-propyl or iso-propyl acrylate or the corresponding methacrylates. Mixtures of compatible (meth)acrylate monomers may also be used. Additional monomers that may be used include the vinyl esters (vinyl acetate and vinyl propionate), vinyl ethers, fumarates, maleates, styrene, acrylonitrile, ethylene, etc. as well as comonomers thereof. The hydroxyl containing monomers may be the same or different from the monomers used in the remainder of the acrylic polymerization. The particular monomers selected will depend, in large part, upon the end use for which the adhesives are intended. Thus, adhesives to be used in pressure sensitive applications or in applications wherein adhesion to metal is required will be selected to obtain a lower Tg polymer than may be desired in non-pressure sensitive applications or those involving more easily bonded substrates.

When the adhesive is to be prepared utilizing monomeric materials, the respective monomers may be added to the polyols and polymerized therein prior to formation of the prepolymer or may be added to the already formed prepolymer and the acrylic polymerization subsequently performed. In the case of polyamino or polymercapto containing prepolymers, in-situ vinylic polymerization must be performed only in the pre-formed prepolymer.

The hydroxyl containing ethylenically unsaturated monomer is polymerized using conventional free radical polymerization procedures to a relatively low molecular weight. For purposes of clarification, use of the term “low molecular weight” means number average molecular weights in the range of approximately 1,000 to 50,000, preferred for use are monomers having an average molecular weight in the range of from about 5,000 to about 30,000. Molecular weight distribution is characterized by Gel Permeation Chromatography using a PL Gel, Mixed 10 micron column, a Shimadzu Model RID 6A Detector with a tetrahydrofuran carrier solvent at a flow rate of 1 milliliter per minute. The low molecular weight is obtained by carefully monitoring and controlling the reaction conditions and, generally, by carrying out the reaction in the presence of a chain transfer agent such as dodecyl mercaptan. Subsequent to the polymerization of the ethylenically unsaturated monomer(s), the polyisocyanate and any additional ingredients required for the urethane prepolymer forming reaction are added and that reaction is carried out using conventional condensation polymerization procedures. In this manner, the resultant isocyanate terminated urethane prepolymer forms the reactive curing hot melt adhesive described above which contains about 2 to about 90% of the low molecular weight hydroxyl containing polymer.

It is also possible to polymerize the low molecular weight polymer in the presence of the already formed isocyanate terminated urethane prepolymer. This method has the drawback of subjecting the prepolymer to unnecessary heating during the acrylic polymerization, heating that might result in branching, viscosity increase, depletion of needed isocyanate groups and possible gellation. Although these disadvantages are subject to control, more stringent control of conditions is required as compared to polymerization in the non-isocyanate functional urethane components. When the reaction is run in the polyol or other non-isocyanate containing component, there is also the advantage of lower reaction viscosities and reduced exposure to isocyanate vapors because of the lesser amount of heating required.

Optionally, the hydroxyl containing functionality may be introduced into the adhesive in the form of pre-polymerized low molecular weight hydroxyl containing polymers. In the latter case, typical polymers include hydroxyl substituted butyl acrylate, hydroxylated butyl acrylate/methyl methacrylate copolymers, hydroxylated ethyl acrylate/methyl methacrylate copolymers, and the like. Preferred polymers have a number average molecular weight of 5,000 to 30,000 and a hydroxyl number of 4 to 30. If used in the form of low molecular weight polymers, the polymers may be blended with the polyol prior to reaction thereof with the isocyanate or they may be added directly to the isocyanate terminated prepolymer.

While the adhesives may be used directly as described above, if desired the adhesives of the present invention may also be formulated with conventional additives that are compatible with the composition. Such additives include plasticizers, compatible tackifiers, curing catalysts, dissociation catalysts, fillers, anti-oxidants, pigments, adhesion promoters, stabilizers, aliphatic C₅-C₁₀ terpene oligomers and the like. Conventional additives that are compatible with a composition according to this invention may simply be determined by combining a potential additive with the composition and determining if they are compatible. An additive is compatible if it is homogenous within the product. Non-limited examples of suitable additives include, without limitation, rosin, rosin derivatives, rosin ester, aliphatic hydrocarbons, aromatic hydrocarbons aromatically modified aliphatic hydrocarbons, terpenes, terpene phenol, modified terpene, high molecular weight hindered phenols and multifunctional phenols such as sulfur and phosphorous-containing phenol, terpene oligomers, 2,2-dimorpholino diethylether, or DMDEE, amine catalyst, tin catalysts, organometallic catalysts, paraffin waxes, microcrystalline waxes, castor oil and hydrogenated castor oil.

The reactive hot melt adhesives of the invention may also contain flame retardant components. Fire retardant additives known in the art for imparting flame resistance to polyurethane compositions may be added. Such compounds include inorganic compounds such as a boron compound, aluminum hydroxide, antimony trioxide and the like, and other halogen compounds including halogen-containing phosphate compounds such as tris(chloroethyl)phosphate, tris(2,3-dichloropropyl)-phosphate, and the like. In a preferred embodiment, ethylenebistetrabromophthalimide and/or tris(2,3-dibromopropyl)-isocyanurate is added as a prime flame retardant component. The ethylenebistetrabromophthalimide and/or tris(2,3-dibromopropyl)isocyanurate may be used with or without other flame retardants. The composition may further comprise a chlorinated paraffin and/or an aryl phosphate ester as a further flame retardant component. The optional chlorinated paraffin imparts flame retardancy as well as performing as a viscosity modifier. The aryl phosphate ester further imparts improved adhesion to the substrates. The flame retardant polyurethane-based reactive hot melt adhesives when used in the practice of the invention gives excellent flame retardancy while maintaining the targeted properties of the base polymer, such as good green strength, controlled setting speed and good thermal stability at elevated temperatures.

As used herein, “irreversible solid form” means a solid form comprising polyurethane polymers extended from the aforementioned polyurethane prepolymers. The composition having the irreversible solid form typically can withstand temperatures of up to 150° C. Using a flame retardant the thermal stability of the irreversible solid can be improved.

The invention is further illustrated by the following non-limiting examples.

### EXAMPLES

### Example 1

Reactive hot melt adhesives having the formulations shown in Table 1 (% by weight) were prepared. All the polyols and acrylic polymers (reactive or not) were added to melt and mix under vacuum until homogeneous and free of moisture. Then MDI was added and polymerization allowed to proceed with mixing under vacuum until reaction is complete. The resulting pre-polymer was then placed into a container under a dry. nitrogen headspace to prevent exposure to moisture. Formulations C and D contain a mono functional grafting agent and formulations A and B do not.

TABLE 1
Formulations of Reactive Hot Melt Adhesives With and
Without Monofunctional Grafting Agents

| Sample | A | B | C | D |
|---|---|---|---|---|
| Modaflow | 0.1 | 0. | 0.4 | 40.4 |
| PPG 2025 | 15.6 | 31.9 | 13.8 | 11.3 |
| PPG 4025 | 30.8 | 16.1 | 46.9 | 38.5 |
| ELVACITE 2820 | 8.0 | 10.5 | — | — |
| ELVACITE 2903 | — | — | 11.4 | — |
| ELVACITE 2902 | — | — | — | 0.3 |
| ELVACITE 2967 | 24.3 | 13.7 | 3.8 | 27.8 |
| DYNACOLL | 9.8 | 10.0 | — | — |
| 7360 | | | | |
| DYNACOLL | — | 6.0 | — | — |
| 7380 | | | | |
| UMB1001 | — | — | — | 1.5 |
| UNILIN 350 | — | — | — | 8.7 |
| UNILIN 425 | — | — | 10.6 | — |
| SILQUEST | 0.5 | 0.5 | — | — |
| Y9030 | | | | |
| SILQUEST | — | — | 0.5 | 0.5 |
| A1110 | | | | |
| DMDEE | 0.2 | 0.2 | 0.2 | 0.2 |
| MDI | 10.7 | 11.0 | 12.4 | 10.8 |

ELVACITE 2902 (a 60,000 Mw acrylic - available from Lucite)
ELVACITE 2903 (a 25,000 Mw acrylic - available from Lucite)
ELVACITE 2967 (an 18,500 Mw acrylic - available from Lucite)
ELVACITE 2820 (a 24,000 Mw acrylic - available from Lucite)
DYNACOLL 7360 (a 3750 MW hexaediol adipate available from Creanova)
DYNACOLL 7380 (a 3750 MW hexanediol, dodecanediol adipate copolymer available from DeGussa)
UMB1001 (a 1000 Mw acrylic monol available from Esprix)
PPG 2025 (polypropylene glycol, molecular weight 2000, available from Arch)
PPG 4025 (polypropylene glycol, molecular weight 4000, available from Arch)
MODAFLOW (an acrylic defoamer available from Solutia)
UNILIN 350 (a 350 Mn polyethylene monoalcohol available from Baker Petrolites)
UNILIN 425 (a 425 Mn polyethylene monoalcohol available from Baker Petrolites)
SILQUEST Y9030 (gamma-isocyanatopropyl-triethoxysilane available from Crompton)
SILQUEST A1110 (aminopropyltrimethoxysilane available from Crompton)

The results of testing on the formulas of Table 1 are illustrated in Table 2.

TABLE 2
Reactive Hot Melt Properties With and Without Monofunctional Grafting Agents

| Sample | A | B | C | D |
|---|---|---|---|---|
| Modulus | 443.4 ± 14.3 | 1503.5 ± 164.8 | 433.9 ± 34.4 | 86.7 ± 15.5 |
| Max. Stress (psi) | 562.3 ± 74.3 | 1211.7 ± 292.6 | 42.7 ± 21.6 | 34.0 ± 2.8 |
| Strain @ Break (%) | 466.3 ± 59.8 | 801.8 ± 93.3 | 116.3 ± 20.3 | 488.4 ± 77.7 |
| Energy to Break | 9.8 ± 2.1 | 29.6 ± 7.7 | 0.309 ± 0.049 | 1.06 ± 0.098 |
| (J/cm³) | | | | |

Table 2 illustrates that the cohesive strength of the reactive hot melt containing the monofunctional grafting agent is significantly reduced and that the adhesive is soft and easily cut. While the adhesive having the monofunctional grafting agent has a lower modulus, lower maximum stress and lower energy to break, the adhesive maintains a strain to break percentage that is comparable to the adhesives without the monofunctional grafting agent.

### Example 2

Formulations A, B and D were applied to glass and the time to deglaze the material was evaluated. Beads of ⅛″ were applied to the glazing leg of a window frame. Formulation A was applied at 180F, formulation B at 260F and formulation D at 150F. The bead of adhesive was placed either in the center of the glazing leg of the window frame or near the nub, a raised portion of the glazing leg, which provides clearance between the frame and glass pane. Tests were performed both with and without clearance between the glass and the glazing leg. The window was deglazed with either a standard utility knife or a PURFECT™ deglazing tool (“PDG”). The deglazing process comprised the step of inserting the knife or deglazing tool between the glass and the glazing leg of the window frame along the interior perimeter of the frame. The time to deglaze was determined to be the total time required to cut through the glazing material so that the glass could be removed from the frame. The results of the testing are illustrated in Table 3.

TABLE 3
Deglazing of Reactive Hot Melt Adhesives

| | Bead | | | Time |
|---|---|---|---|---|
| Formulation | Placement | Clearance | Tool | (Minutes) |
| A (2 tests) | Center | Yes | Knife | 3.8 |
| A (3 tests) | Center | Yes | PDG | 3.1 |
| A (1 test) | Near Nub | Yes | Knife | 3.5 |
| A (2 tests) | Near Nub | No | Knife | 4.5 |
| B (2 tests) | Near Nub | Yes | Knife | 4.0 |
| B (1 test) | Near Nub | No | Knife | 7.0 |
| B (1 test) | Near Nub | No | PDG | 6.3 |
| B (1 test) | Near Nub | Yes | PDG | 5.2 |
| B (2 tests) | Center | Yes | PDG | 4.5 |
| D (5 tests) | Center | Yes | Knife | 1.0 |
| D (3 tests) | Center | Yes | PDG | 0.7 |

As clearly shown in Table 3, the formulation containing the monofunctional grafting agent produced faster deglazing times than the material without the monofunctional grafting agent.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A method of manufacturing a window comprising the steps of:
a) providing a plurality of substrates;
b) applying a reactive hot melt adhesive to at least one of the plurality of substrates; and
c) combining the plurality of substrates such that the reactive hot melt adhesive forms a bond between the substrates,
wherein the reactive hot melt adhesive comprises at least one multifunctional isocyanate component, at least one monofunctional reactant component, optionally a polyester polyol component, optionally a thermoplastic polymer and optionally a polyether polyol component.

2. The method of claim 1, wherein the reactive hot melt adhesive has a hardness of less than about 70 Shore A.

3. The method of claim 2, wherein the reactive hot melt is a silicone reactive hot melt.

4. The method of claim 2, wherein the reactive hot melt is a polyurethane reactive hot melt.

5. The method of claim 2, wherein the reactive hot melt is a foamed silicone reactive hot melt.

6. The method of claim 2, wherein the reactive hot melt is a foamed polyurethane reactive hot melt.

7. The method of claim 1, wherein the plurality of substrates comprise at least one glass pane and at least one frame.

8. The method of claim 7, wherein the frame is vinyl, aluminum, wood or fiberglass composite.

9. A method of deglazing a window comprising the steps of:
a) providing a window having one or more glass panes that are glazed to a frame using a reactive hot melt adhesive;
b) cutting the reactive hot melt adhesive so that the glass pane and window frame may be separated from each other,
wherein the reactive hot melt adhesive comprises at least one multifunctional isocyanate component, at least one monofunctional reactant component, optionally a polyester polyol component, optionally a thermoplastic polymer and optionally a polyether polyol component.

10. The method of claim 9, wherein the reactive hot melt adhesive has a hardness of less than about 70 Shore A.

11. The method of claim 10, wherein the reactive hot melt is a silicone reactive hot melt.

12. The method of claim 10, wherein the reactive hot melt is a polyurethane reactive hot melt.

13. The method of claim 10, wherein the reactive hot melt is a foamed silicone reactive hot melt.

14. The method of claim 10, wherein the reactive hot melt is a foamed polyurethane reactive hot melt.

15. The window of claim 10, wherein the frame is vinyl, aluminum, wood or fiberglass composite.

16. The method of claim 10, further comprising the step of applying heat to the reactive hot melt adhesive before it is cut.
